(19) United States
(12) Patent Application Publication
(10) Pub. No.: US 2026/0223160 A1
(43) Pub. Date: Jul. 30, 2026

(54) CHANNEL OCCUPANCY TIME SHARING FOR SIDELINK COMMUNICATIONS

(71) Applicant: QUALCOMM Incorporated, San Diego, CA (US)

(72) Inventors: Giovanni CHISCI, San Diego, CA (US); Chih-Hao LIU, San Diego, CA (US); Jing SUN, San Diego, CA (US); Stelios STEFANATOS, San Diego, CA (US); Xiaoxia ZHANG, San Diego, CA (US)

(21) Appl. No.: 19/158,220

(22) PCT Filed: Feb. 29, 2024
(86) PCT No.: PCT/US2024/017933

§ 371 Date: Aug. 20, 2025

(30) Foreign Application Priority Data
Apr. 20, 2023 (GR) 20230100333

(51) Int. Cl. H04W 74/04; H04W 56/00; H04W 92/18

(52) U.S. Cl. CPC H04W 74/04; H04W 56/001; H04W 92/18

(57) ABSTRACT

Various aspects of the present disclosure generally relate to wireless communication. In some aspects, a first user equipment (UE) may generate an indication that a second UE is able to transmit a communication during a portion of a channel occupancy time (COT) used by the first UE, the portion being smaller in duration than the COT. The UE may transmit the indication to the second UE. Numerous other aspects are described.

### CROSS-REFERENCE TO RELATED APPLICATION

This Patent Application claims priority to Greece Patent Application No. 20230100333, filed on Apr. 20, 2023, entitled “CHANNEL OCCUPANCY TIME SHARING FOR SIDELINK COMMUNICATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for channel occupancy time sharing for sidelink communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include generating an indication that a second UE is able to transmit a communication during a portion of a channel occupancy time (COT) used by the first UE, the portion being smaller in duration than the COT. The method may include transmitting the indication to the second UE.

Some aspects described herein relate to a method of wireless communication performed by a second UE. The method may include obtaining information that the second UE is able to transmit a communication during a portion of a COT used by a first UE, the portion being smaller in duration than the COT. The method may include transmitting the communication during the portion of the COT.

Some aspects described herein relate to a method of wireless communication performed by a second UE. The method may include obtaining a first indication of a first COT used by a first UE and that can be shared with the first UE. The method may include transmitting a sidelink synchronization signal block (S-SSB) or a physical sidelink feedback channel (PSFCH) communication in a portion of the first COT, based at least in part on the first indication.

Some aspects described herein relate to a method of wireless communication performed by a first UE. The method may include transmitting a physical sidelink channel communication in a first portion of a COT used by the first UE. The method may include selectively transmitting a communication in a second portion of the COT within a COT interruption gap duration based at least in part on a determination of whether the first UE is to use the second portion.

Some aspects described herein relate to a first UE for wireless communication. The first user equipment may include a memory and one or more processors coupled to the memory. The one or more processors may be configured to generate an indication that a second UE is able to transmit a communication during a portion of a COT used by the first UE, the portion being smaller in duration than the COT. The one or more processors may be configured to transmit the indication to the second UE.

Some aspects described herein relate to a second UE for wireless communication. The second user equipment may include a memory and one or more processors coupled to the memory. The one or more processors may be configured to obtain information that the second UE is able to transmit a communication during a portion of a COT used by a first UE, the portion being smaller in duration than the COT. The one or more processors may be configured to transmit the communication during the portion of the COT.

Some aspects described herein relate to a UE for wireless communication. The UE may include a memory and one or more processors coupled to the memory. The one or more processors may be configured to obtain a first indication of a first COT used by a first UE and that can be shared with the first UE. The one or more processors may be configured to transmit an S-SSB or a PSFCH communication in a portion of the first COT, based at least in part on the first indication.

Some aspects described herein relate to a UE for wireless communication. The UE may include a memory and one or more processors coupled to the memory, The one or more processors may be configured to transmit a physical sidelink channel communication in a first portion of a COT used by the first UE. The one or more processors may be configured to selectively transmit a communication in a second portion of the COT within a COT interruption gap duration based at least in part on a determination of whether the first UE is to use the second portion.

Some aspects described herein relate to a non-transitory computer-readable medium that stores a set of instructions for wireless communication by a first UE. The set of instructions, when executed by one or more processors of the first UE, may cause the first UE to generate an indication that a second UE is able to transmit a communication during a portion of a COT used by the first UE, the portion being smaller in duration than the COT. The set of instructions, when executed by one or more processors of the first UE, may cause the first UE to transmit the indication to the second UE.

Some aspects described herein relate to a non-transitory computer-readable medium that stores a set of instructions for wireless communication by a second UE. The set of instructions, when executed by one or more processors of the second UE, may cause the second UE to obtain information that the second UE is able to transmit a communication during a portion of a COT used by a first UE, the portion being smaller in duration than the COT. The set of instructions, when executed by one or more processors of the second UE, may cause the second UE to transmit the communication during the portion of the COT.

Some aspects described herein relate to a non-transitory computer-readable medium that stores a set of instructions for wireless communication by a second UE. The set of instructions, when executed by one or more processors of the second UE, may cause the second UE to obtain a first indication of a first COT used by a first UE and that can be shared with the first UE. The set of instructions, when executed by one or more processors of the second UE, may cause the second UE to transmit an S-SSB or a PSFCH communication in a portion of the first COT, based at least in part on the first indication.

Some aspects described herein relate to a non-transitory computer-readable medium that stores a set of instructions for wireless communication by a first UE. The set of instructions, when executed by one or more processors of the first UE, may cause the first UE to transmit a physical sidelink channel communication in a first portion of a COT used by the first UE. The set of instructions, when executed by one or more processors of the first UE, may cause the first UE to selectively transmit a communication in a second portion of the COT within a COT interruption gap duration based at least in part on a determination of whether the first UE is to use the second portion.

Some aspects described herein relate to an apparatus for wireless communication. The apparatus may include means for generating an indication that another apparatus is able to transmit a communication during a portion of a COT used by the apparatus, the portion being smaller in duration than the COT. The apparatus may include means for transmitting the indication to the other apparatus.

Some aspects described herein relate to an apparatus for wireless communication. The apparatus may include means for obtaining information that the apparatus is able to transmit a communication during a portion of a COT used by another apparatus, the portion being smaller in duration than the COT. The apparatus may include means for transmitting the communication during the portion of the COT.

Some aspects described herein relate to an apparatus for wireless communication. The apparatus may include means for obtaining a first indication of a first COT used by another apparatus and that can be shared with the apparatus. The apparatus may include means for transmitting an S-SSB or a PSFCH communication in a portion of the first COT, based at least in part on the first indication.

Some aspects described herein relate to an apparatus for wireless communication. The apparatus may include means for transmitting a physical sidelink channel communication in a first portion of a COT used by the apparatus. The apparatus may include means for selectively transmitting a communication in a second portion of the COT within a COT interruption gap duration based at least in part on a determination of whether the apparatus is to use the second portion.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution,

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of selecting sidelink resources, in accordance with the present disclosure.

FIG. 6 is a diagram illustrating an example of sidelink synchronization signal block (S-SSB) transmission in a channel occupancy time (COT), in accordance with the present disclosure.

FIG. 7 is a diagram illustrating an example of transmission during a COT, in accordance with the present disclosure.

FIG. 8 is a diagram illustrating an example associated with COT sharing, in accordance with the present disclosure.

FIGS. 9 and 10 are diagrams illustrating examples of using COT interruption gaps, in accordance with the present disclosure.

FIG. 11 is a diagram illustrating an example of responder UE transmission, in accordance with the present disclosure.

FIG. 12 is a diagram illustrating an example of transmission during a COT, in accordance with the present disclosure.

FIG. 13 is a diagram illustrating an example associated with a responder UE transmitting a communication during a COT of another UE, in accordance with the present disclosure.

FIG. 14 is a diagram illustrating an example of using a COT, in accordance with the present disclosure.

FIG. 15 is a diagram illustrating an example of using a COT, in accordance with the present disclosure.

FIG. 16 is a diagram illustrating an example process performed, for example, by a UE, in accordance with the present disclosure.

FIG. 17 is a diagram illustrating an example process performed, for example, by a UE, in accordance with the present disclosure.

FIG. 18 is a diagram illustrating an example process performed, for example, by a UE, in accordance with the present disclosure.

FIG. 19 is a diagram illustrating an example process performed, for example, by a UE, in accordance with the present disclosure.

FIG. 20 is a diagram of an example apparatus for wireless communication, in accordance with the present disclosure.

### DETAILED DESCRIPTION

A first user equipment (UE) (UE1) may use a channel occupancy time (COT), which may be duration of time (e.g., following a successful channel access procedure of unlicensed sidelink communications) during which UE1 is able to transmit over other UEs. The UE1 may share the COT with a second UE (UE2), However, UE1 may not want to share the whole COT. Existing rules for COT sharing may prohibit limited sharing of the COT. This may be an issue with UE2's ability to transmit a high priority communication, such as a sidelink synchronization signal block (S-SSB). It is expected that S-SSBs are not to be blocked.

However, if UE1 is performing a transmission burst in a COT, there are multiple communications in sequence with gaps of 16 μs or less. UE1 may use a cyclic prefix extension (CPE) to fill the gap to reduce it up to 16 μs. When this is done before an S-SSB transmission of UE2, this would hinder the access for UE2, which is expecting to be able to work with a gap of 25 μs. As a result, UE2 may have to wait until an end of the COT used by UE1, which could be 5 milliseconds (ms). This introduces latency.

According to various aspects described herein, UE2 may be configured to share the COT for a limited portion of the COT (not the whole COT), such as during the S-SSB occasion, even if the COT interruption gap is less than 25 μs. This may include relaxing a restriction on COT sharing to allow transmission of the S-SSB if the COT interruption gap is less than 25 μs (e.g., 16 μs or less). As a result of allowing UE2 to transmit a communication (e.g., S-SSB) during a portion of the COT instead of waiting until after the COT, the latency of UE2's communications is reduced.

In some aspects, a restriction on COT sharing may be relaxed to allow transmission of a physical sidelink feedback channel (PSFCH) communication if the COT interruption gap is less than 25 μs (e.g., 16 μs or less). As a result of allowing UE2 to transmit a PSFCH communication during a portion of the COT instead of waiting until after the COT, the latency of UE2's communications is reduced.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

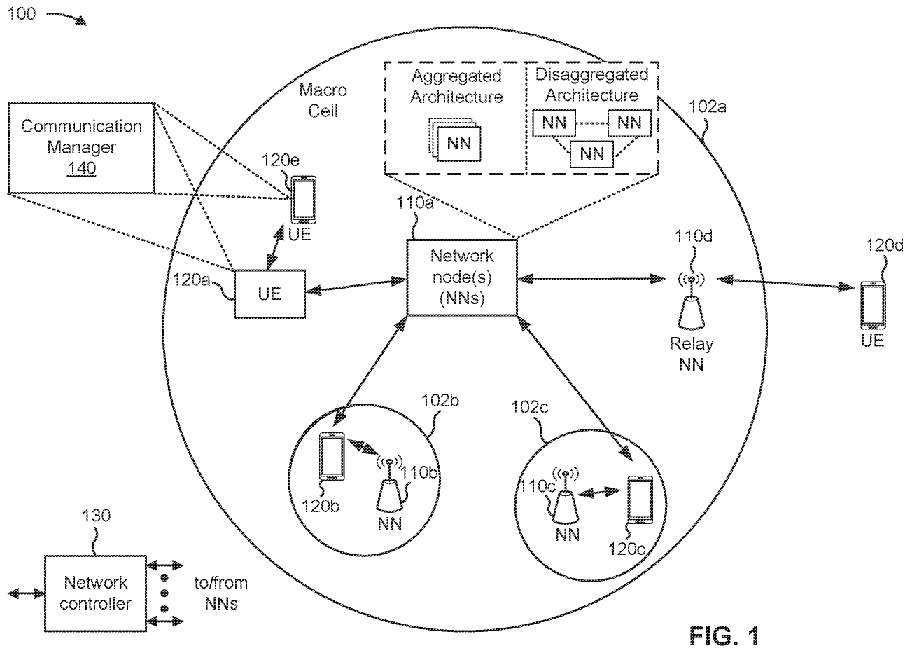

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network. nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like, Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FRI characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., a UE 120) may include a communication manager 140. As described in more detail elsewhere herein, the communication manager 140 may generate an indication that a second UE is able to transmit a communication during a portion of a COT used by the first UE, the portion being smaller in duration than the COT. The communication manager 140 may transmit the indication to the second UE.

In some aspects, communication manager 140 may transmit a physical sidelink channel communication in a first portion of a COT used by the first UE. The communication manager 140 may selectively transmit a communication in a second portion of the COT within a COT interruption gap duration based at least in part on a determination of whether the first UE is to use the second portion. Additionally, or alternatively, the communication manager 140 may perform one or more other operations described herein.

In some aspects, a second UE (e.g., a UE 120) may include a communication manager 140. As described in more detail elsewhere herein, the communication manager 140 may obtain information that the second UE is able to transmit a communication during a portion of a COT used by a first UE, the portion being smaller in duration than the COT. The communication manager 140 may transmit the communication during the portion of the COT, In some aspects, the communication manager 140 may obtain a first indication of a first COT used by a first UE and that can be shared with the first UE. The communication manager 140 may transmit an S-SSB or a PSFCH communication in a portion of the first COT, based at least in part on the first indication. Additionally, or alternatively, the communication manager 140 may perform one or more other operations described herein.

As indicated above, FIG. 1 is provided as an example. Other examples may differ from what is described with regard to FIG. 1.

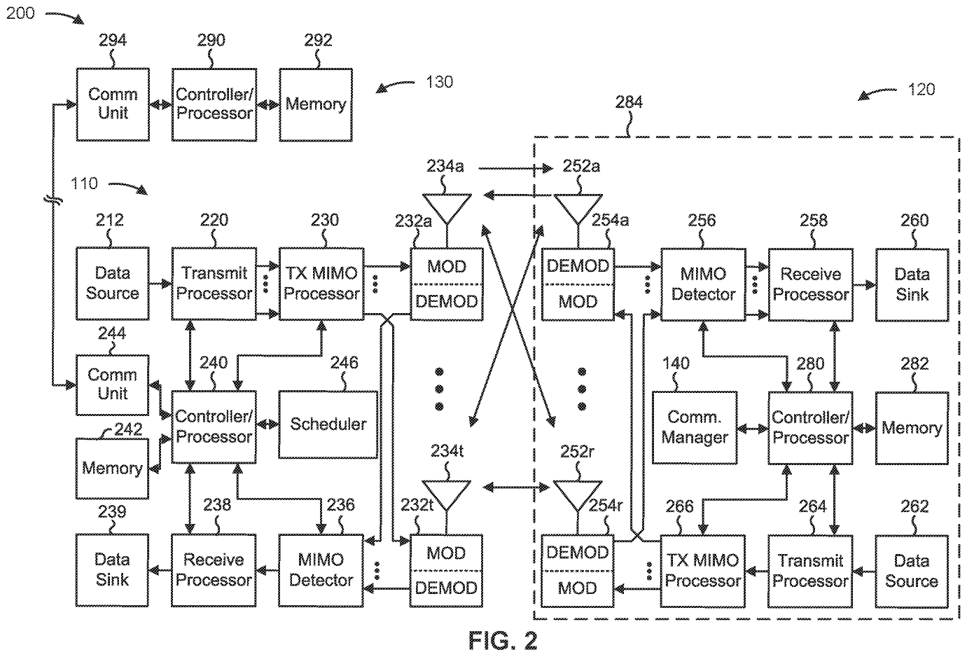

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., 7 modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings). a set of coplanar antenna elements, a set of non-coplanar antenna elements, and/or one or more antenna elements coupled to one or more transmission and/or reception components, such as one or more components of FIG. 2.

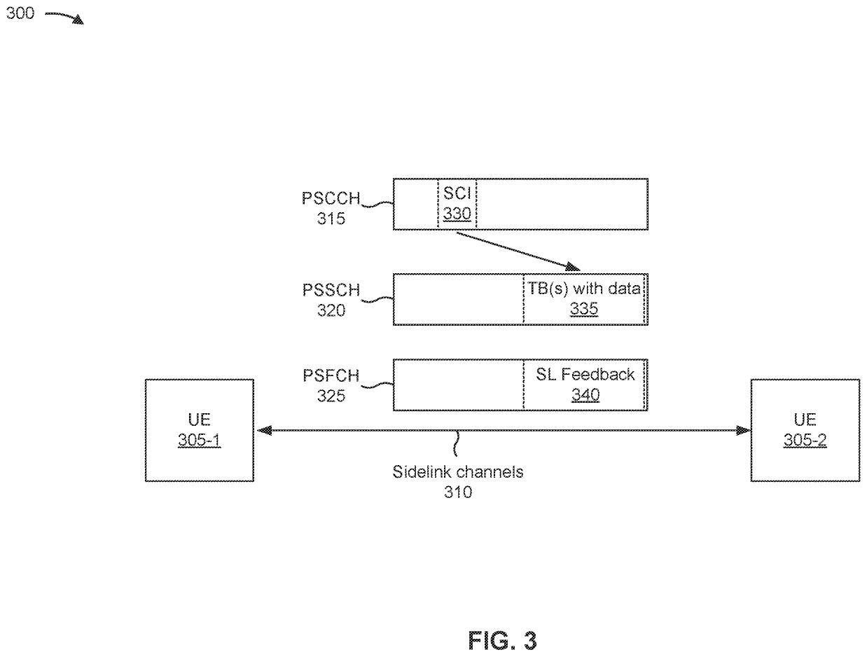

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DET-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-20).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-20).

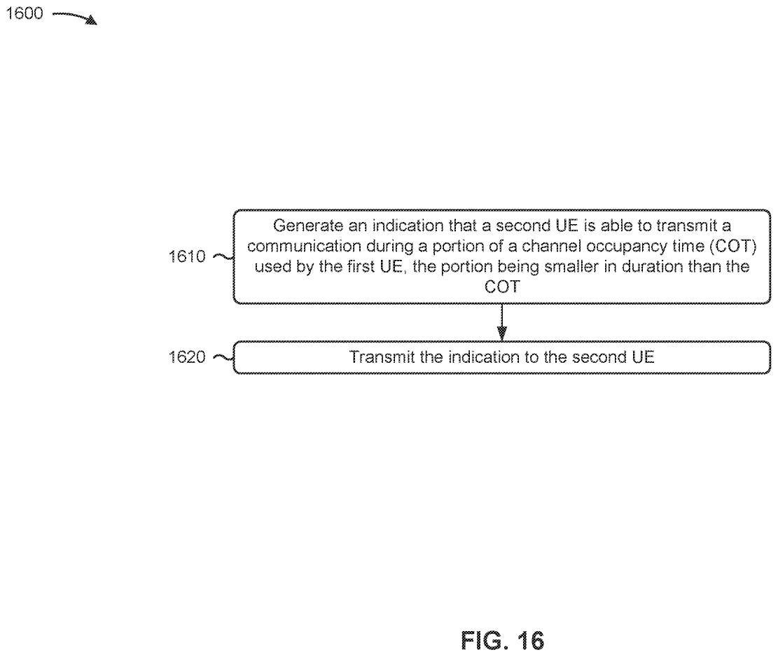

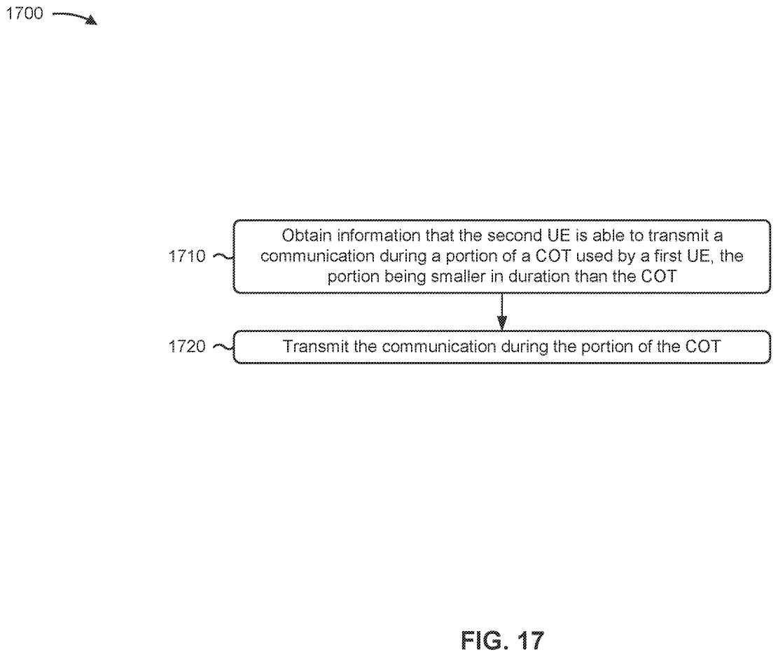

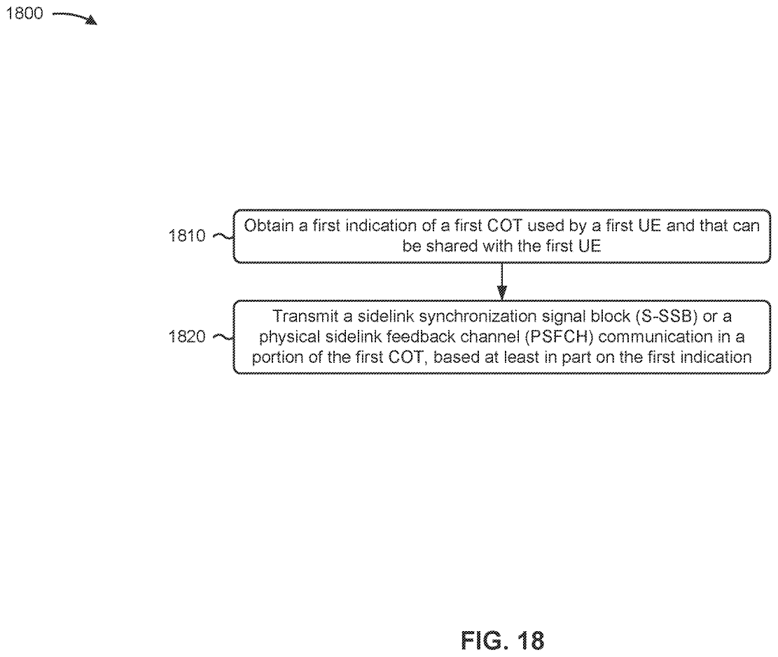

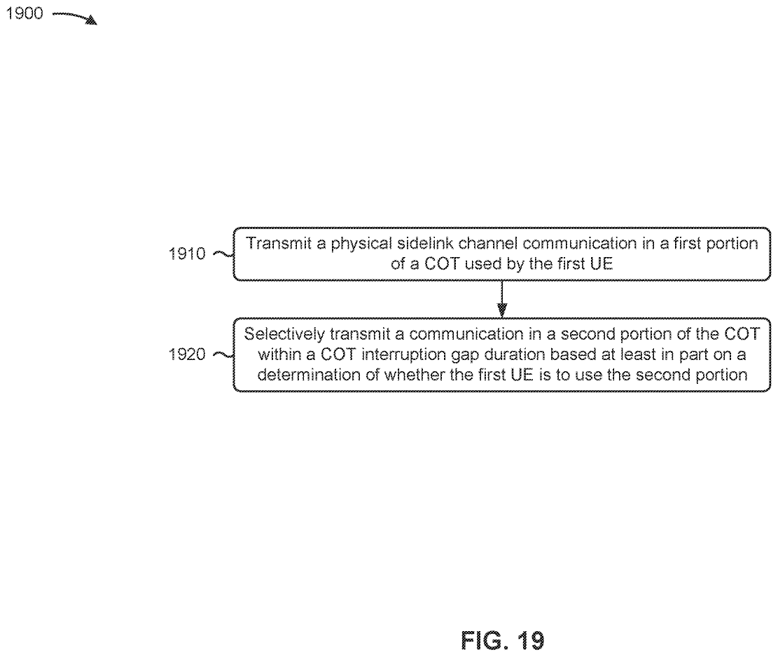

A controller/processor of a network entity (e.g., controller/processor 240 of the network node 110), the controller/processor 280 of the UE 120, and/or any other component(s) of FIG. 2 may perform one or more techniques associated with allowing transmissions during a portion of a channel occupancy time, as described in more detail elsewhere herein. For example, the controller/processor 240 of the network node 110, the controller/processor 280 of the UE 120, and/or any other component(s) of FIG. 2 may perform or direct operations of, for example, process 1600 of FIG. 16, process 1700 of FIG. 17, process 1800 of FIG. 18, process 1900 of FIG. 19, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1600 of FIG. 16, process 1700 of FIG. 17, process 1800 of FIG. 18, process 1900 of FIG. 19, and/or other processes as described herein. In some examples, executing instructions may include running the instructions, converting the instructions, compiling the instructions, and/or interpreting the instructions, among other examples.

In some aspects, a first UE (e.g., a UE 120) includes means for generating an indication that a second UE is able to transmit a communication during a portion of a COT used by the first UE, the portion being smaller in duration than the COT; and/or means for transmitting the indication to the second UE. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the first UE includes means for transmitting a physical sidelink channel communication in a first portion of a COT used by the first UE; and/or means for selectively transmitting a communication in a second portion of the COT within a COT interruption gap duration based at least in part on a determination of whether the first UE is to use the second portion.

In some aspects, a second UE (e.g., a UE 120) includes means for obtaining information that the second UE is able to transmit a communication during a portion of a COT used by a first UE, the portion being smaller in duration than the COT; and/or means for transmitting the communication during the portion of the COT. The means for the second UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the second UE includes means for obtaining a first indication of a first COT used by a first UE and that can be shared with the first UE; and/or means for transmitting an S-SSB or a PSFCH communication in a portion of the first COT, based at least in part on the first indication.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110. For example, the UE 305 may receive a grant (e.g., in downlink control information (DCI) or in a radio resource control (RRC) message, such as for configured grants) from the network node 110 for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

A medium access command (MAC) protocol data unit (PDU) sub-header may include a source ID (e.g., 16 bit SRC) and a destination ID (e.g., 9 bit DST). SCI may include a 16 bit destination ID and an 8 bit source ID. If a TB is associated with unicast, the DST field of the decoded MAC PDU sub-header is equal to the 8 most significant bits (MSB) of any of the source Layer-2 ID(s) of the UE for which the 16 least significant bits (LSB) are equal to the destination ID in the corresponding SCI, and the SRC field of the decoded MAC PDU sub-header is equal to the 16 MSB of any of the destination Layer-2 ID(s) of the UE for which the 8 LSB are equal to the source ID in the corresponding SCI. For unicast, a receiver UE is expected to check both the source ID and the destination ID. If the TB is associated with groupcast or broadcast and the DST field of the decoded MAC PDU sub-header is equal to the 8 MSB of any of the destination Layer-2 ID(s) of the UE for which the 16 LSB are equal to the destination ID in the corresponding SCI, the receiver UE is expected to only check the destination ID.

As indicated above, FIG. 3 is provided as an example. Other examples may differ from what is described with respect to FIG. 3.

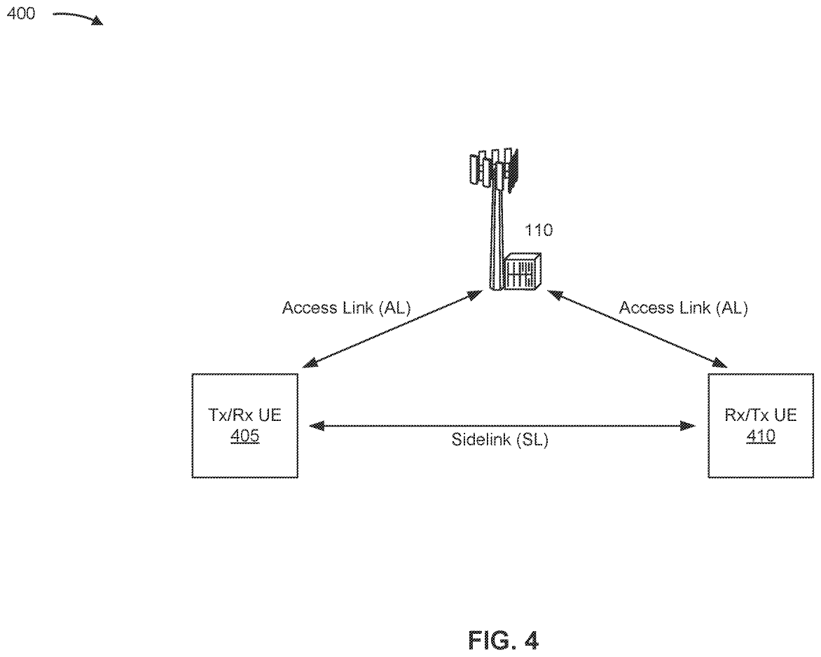

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 via a first access link. Additionally, or alternatively, in some sidelink modes, the network node 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

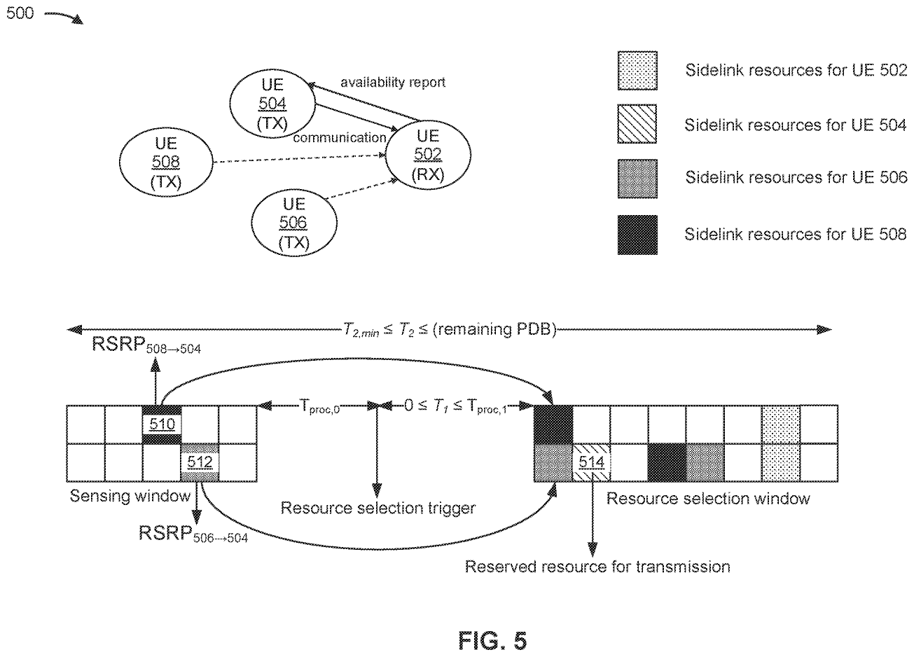

FIG. 5 is a diagram illustrating an example 500 of selecting sidelink resources, in accordance with the present disclosure. Example 500 shows a UE 502 (e.g., a UE 502) that may receive communications on a sidelink channel from other UEs, such as UE 504, UE 506, and/or UE 508.

As described in connection with FIG. 5, UE 504 is a transmitting UE that is transmitting communications to UE 502, which is a receiving UE. UE 504 may use a report from UE 502, which may act as a reporting UE that reports available sidelink resources, preferred sidelink resources, non-preferred sidelink resources, or sidelink resource conflicts. Example 500 shows an availability report from UE 502 to UE 504 and a communication from UE 504 to UE 502.

If UE 504 is to transmit a communication to UE 502, UE 504 may sense the sidelink channel in a sensing window to determine which sidelink resources (e.g., subcarriers, subchannels) are available. UE 504 may use a listen-before-talk (LBT) procedure to sense the channel. The LBT procedure maybe a type 1 LBT procedure, where UE 504 listens for multiple slots (e.g., 9 milliseconds (ms)) and uses a counter. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 504 may measure DMRSs on a PSCCH or a PSSCH, according to a configuration.

For example, UE 504 may prepare to transmit a communication to UE 502. UE 504 may have already sensed previous sidelink resources and successfully decoded SCI from UE 506 and UE 508. UE 504 may try to reserve sidelink resources, and thus may check the availability of the future sidelink resources reserved by UE 506 and UE 508 by sensing the sidelink channel in the sensing window. UE 504 may measure an RSRP of a signal from UE 508 in sidelink resource 510, and an RSRP of a signal from UE 506 in sidelink resource 512. If an observed RSRP (RSRP projection) satisfies the RSRP threshold (e.g., is lower than a maximum RSRP), the corresponding sidelink resource may be available for reservations by UE 504. UE 504 may reserve the sidelink resource (which may be a random selection from available resources). For example, UE 504 may select and reserve sidelink resource 514 for transmission. This may be in a time slot after which UE 506 and UE 508 had used sidelink resources, and UE 504 may have sensed these sidelink resources earlier. UE 504 may select and reserve sidelink resources only upon reaching a threshold level (e.g., 20%, 30%, or 50% availability). UE 504 may increase or decrease the RSRP threshold as necessary to arrive at the threshold level. UE 504 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

If UE 504 determines that a channel is clear, the UE 504 may treat the channel as clear for a maximum duration of time, or a COT. If UE 504 does not need to use the whole COT for transmission or reception, UE 504 may share the COT with another UE, such as with UE 502. UE 504 may indicate RBs and a time duration for the COT. UE 504 may be a COT initiator that performs an LBT procedure and starts the COT. UE 504 may transmit data to UE 502 in a PUSCH communication during the COT. UE 502 may be a COT responder and may provide a PSFCH communication to UE 504, in response to the PUSCH communication, during the COT. UE 502 may be considered to be a PSFCH transmitter. UE 502 may perform a type 2 LBT procedure, which is a “one-shot” channel sensing of a much shorter duration (e.g., 16 microseconds) than a duration of a type 1 LBT procedure.

If UE 502 wants to use a PSFCH symbol that is part (e.g., RB) of a shared COT, at least one PSFCH is expected to target the COT initiator. Currently the physical (PHY) layer has all of the COT related information (e.g., RB sets, duration, channel access priority classes) but has limited scope on the ID of the COT initiator, knowing only 8 bits in source ID SCI-2 field corresponding to the 8 LSBs of the 24 bits L2 ID associated with the sidelink session. Type 2 access, which is based only on Layer 1 (L1) IDs, is less reliable. Currently the MAC layer has the full Layer 2 (L2) logical IDs related to sidelink sessions and can reliably map a transmission to a (logical) destination. On the other side, the MAC layer is typically (e.g., for 3GPP standard Release 16 unlicensed NR (NR-U)) unaware of L1 information related to a COT. Such information may include COT sharing information (COT-SI) that indicates the RBs and time domain of the COT. In sum, while in NR-U the relations for COT sharing may be trivial (gNB-UE), in unlicensed sidelink (SL-U), COT sharing and channel access type may depend on IDs. Therefore, the segregation of necessary information in the MAC layer (full L2 IDs) and the PHY layer (COT information), respectively, may be an obstacle.

Another issue is related to how ID information for the PSFCH is handled. The IDs in the MAC/PHY layers are logical IDs (per session) and are not mapped to a specific device. This complicates the use of a shared COT across different transmissions. The PHY/MAC layers do not know if COT sharing is applicable to a PSFCH by decoding the COT-SI from other links or sessions.

One solution, in an example, is to determine if a TB over a PSSCH is eligible to be transmitted on a shared COT based on logical IDs contained in the initiator's transmission or a COT sharing ID (mapped to several logical IDs) contained in COT-SI. A COT responder may determine if the COT responder is a target of COT-SI by reading a known logical ID or a COT sharing ID. The COT responder may determine if the new TB can be transmitted if the COT responder ID matches one of the logical IDs found in the COT initiator's transmission or a logical ID mapped to the COT sharing ID found in the COT initiator's transmission. The COT sharing ID or the logical IDs may enable more targets, enable unicast or groupcast, or enable cross-session COT sharing.

For PSFCH, the COT responder may use a logical ID in the COT-SI, but there may need to be a PSFCH ID in order to determine eligibility of a PSFCH transmission to use a shared COT. This is a PHY layer transmission, and it is up to the PHY layer to decide to use the COT (e.g., based on a mapping of a resource and an L1 source ID in received SCI-2). Differently, for PSSCH, a MAC entity provides information to the PHY layer to populate the SCI, but with MAC to PHY communication, this information is not used for a PSFCH transmission.

There are at least three options for COT sharing eligibility. In a first option (Option 1), a PSFCH transmitter is addressed by a COT initiator (receiving PSSCH or PSSCH scheduling SCI for the PSFCH), and the PSFCH transmission burst contains at least one code division multiplexing (CDM) or frequency division multiplexing (FDM) PSFCH targeting COT initiator. In a second option (Option 2), the PSFCH transmitter is addressed by the COT initiator, and the PSFCH transmission could target any UE. In a third option (Option 3), the PSFCH transmitter is not addressed by the COT initiator but receives COT-SI, and the PSFCH transmission could target any UE, However, for the solutions and options described above, a COT responder (e.g., PSFCH transmitter) may expect further clarity as to whether the COT responder is eligible to share the COT.

In some aspects, a UE may transmit a CPE, which includes a start of a transmission in a gap between a first communication and a second communication. The UE may transmit the CPE in order to start transmission at a starting position that is before a scheduled first symbol of the second communication. There may be one or more CPE starting positions (e.g., 16 μs, 25 μs, 34 μs, 70 μs) before a starting position for an S-SSB, a PSFCH communication, or another physical sidelink channel communication (e.g., PSCCH, PSSCH). The CPE starting position may be configured or indicated.

When performing S-SSB transmissions, a responding UE can utilize a COT shared by a COT initiating UE (using Type 1 channel access) when the responding UE is intended to transmit the S-SSB within RB sets corresponding to the shared COT. When performing PSFCH transmissions, a responding UE can utilize a COT shared by a COT initiating UE at least when at least one of the responding UE's PSFCH transmissions in a symbol/slot within RB set(s) corresponding to the shared COT is intended for the COT initiating UE.

A CPE may be transmitted from a CPE starting position before a sidelink transmission for the following two options: within the symbol just before the next automatic gain control (AGC) symbol; within the symbol just before the next AGC symbol for 15 kilohertz (kHz) subcarrier spacing (SCS); or within at most 2 symbols just before the next AGC symbol for 30 or 60 kHz SCS.

A responding UE over a shared COT may be a receiving UE, which is the target of a PSCCH/PSSCH transmission of a COT initiator. In the case of unicast from the COT initiator, a receiving UE may use the same COT when the source and destination identifiers (IDs) contained in the COT initiator's SCI match to the corresponding destination and source IDs relating to the same unicast at the receiving UE. In the case of groupcast and broadcast, a receiving UE may use the same COT when the destination ID contained in the COT initiator's SCI match to a destination ID known at the receiving UE. A responding UE may be a UE identified by IDs, if additional IDs are supported in the COT-SI (in addition to the source and destination IDs of the PSCCH/PSSCH transmission) and when additional IDs are included in the COT-SI from the COT initiator.

As indicated above, FIG. 5 is provided as an example. Other examples may differ from what is described with regard to FIG. 5.

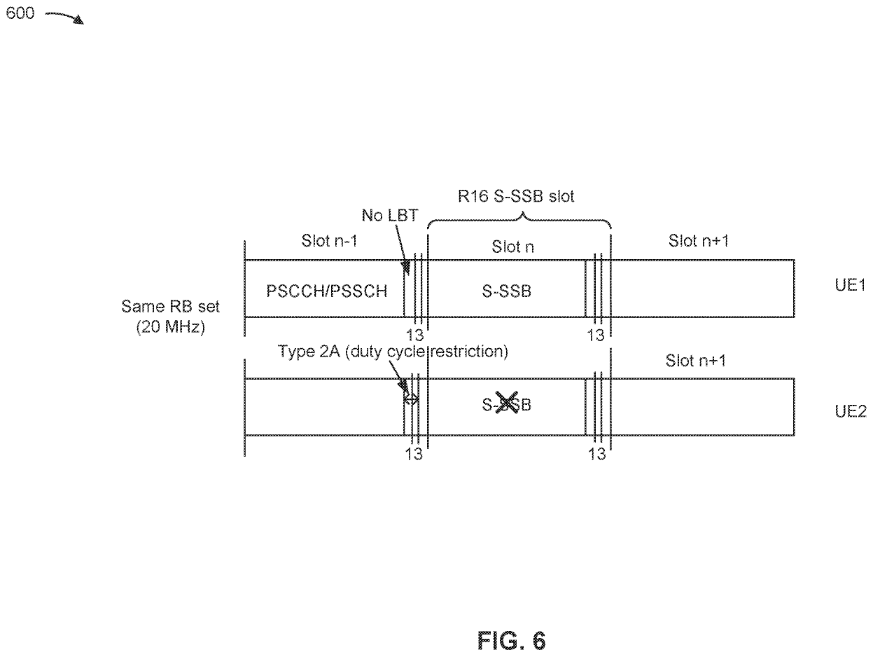

FIG. 6 is a diagram illustrating an example 600 of S-SSB transmission in a COT, in accordance with the present disclosure,

A first UE (UE1) may use a COT. UE1 may share the COT with a second UE (UE2). However, UE1 may not want to share the whole COT. Existing rules for COT sharing may prohibit limited sharing of the COT. This may be an issue with UE2's ability to transmit an S-SSB. An S-SSB may be a high priority transmission that provides a timing synchronization reference to other UEs. It is expected that S-SSBs are not to be blocked and Type 2A channel access with duty cycle restrictions was introduced to help limit S-SSB blocking. CPE positions may be indicated for S-SSB to minimize inter-UE blocking. However, it is intended that a COT interruption gap duration between communications is to be 25 microseconds (μs). If UE1 starts a transmission within the COT interruption gap, UE1 maintains the COT and UE2 is not able to transmit. If UE does not start a transmission within the COT interruption gap, UE1 does not maintain the COT and UE2 may transmit. UE2 may perform a Type 2A channel access before transmitting.

However, if UE1 is performing a transmission burst in a COT, there are multiple communications in sequence with gaps of 16 μs or less. UE1 may use a CPE to fill the gap to reduce it up to 16 μs. When this is done before an S-SSB transmission of UE2, this would hinder the access with Type 2A with duty cycle restrictions (e.g., LBT and measurement structure of 25 μs) for UE2. That is, as shown by example 600, if initiator UE1 transmits a PSCCH/PSSCH in a COT and follows up with an S-SSB in a transmission burst with a 16 μs COT interruption gap duration, UE2 would be blocked from performing a successful Type 2A channel access. UE2 would not be able to transmit an S-SSB in the same S-SSB occasion as UE1. As a result, UE2 may have to wait until an end of the COT used by UE1, which could be 5 ms. This introduces latency.

According to various aspects described herein, UE2 may be configured to share the COT for a limited portion of the COT (not the whole COT), such as during the S-SSB occasion, even if the COT interruption gap is less than 25 μs, such as 16 μs. This may include relaxing a restriction on COT sharing to allow transmission of the S-SSB if the COT interruption gap is less than 25 μs (e.g., 16 μs or less).

In some aspects, UE1 may generate an indication that UE2 is able to transmit a communication during a portion of a COT used by UE1, the portion being smaller in duration than the COT. UE1 may transmit the indication to UE2. UE2 may obtain the indication (e.g., receive the indication, obtain the information from stored configuration information or an early configuration) and transmit the communication during the portion of the COT. By providing UE2 an opportunity to transmit a communication during the portion of the COT (instead of after the COT), UE1 reduces the latency of UE2's communications. UE1 is also not restricted from transmitting data bursts with 16 μs gaps, which may allow UE1 and UE2 use multiple CPE starting positions.

In some aspects, the communication may be an S-SSB, a PSFCH communication, or another high priority communication. By allowing UE2 to transmit an S-SSB, a PSFCH communication, or another high priority communication, UE1 reduces the latency of other communication aspects of UE2's communications.

As indicated above, FIG. 6 is provided as an example. Other examples may differ from what is described with regard to FIG. 6.

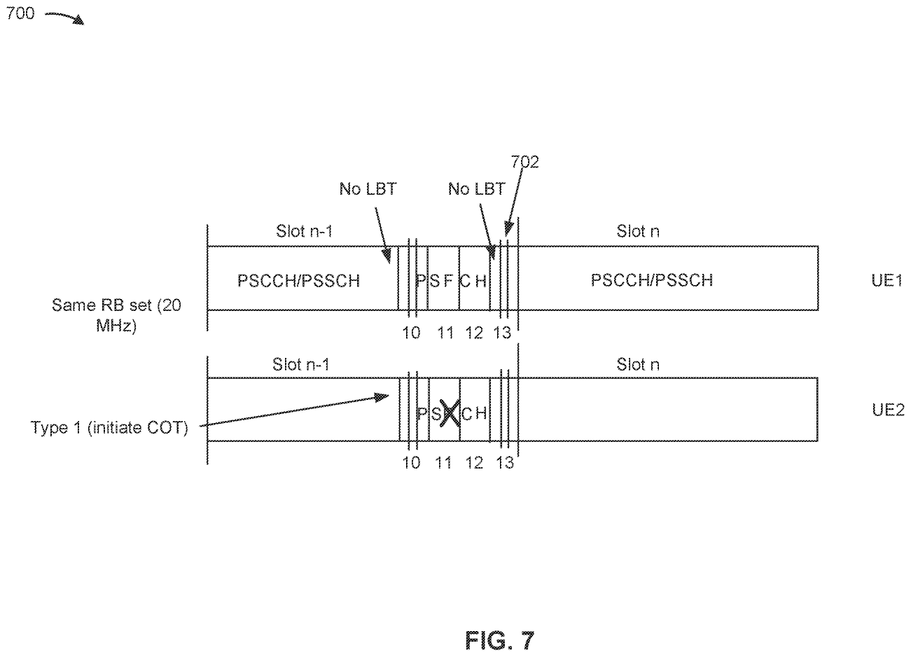

FIG. 7 is a diagram illustrating an example 700 of transmission during a COT, in accordance with the present disclosure.

A PSFCH communication may be a high priority transmission in SL-U that provides feedback to other UEs for a PSSCH communication as part of a HARQ process. It is expected that the transmission of PSFCH communications are not to be blocked. To provide feedback to other UEs, a PSSCH transmission may be associated with HARQ processes. It is intended that a PSFCH communication should be allowed to be FDMed or CDMed as much as possible.

Also, one CPE position may be supported for PSFCH, to minimize inter-UE blocking (a UE2 performing LBT while a UE2 is already transmitting a CPE). It is intended that if the one CPE position is after a gap of 25 μs, it could better avoid inter-UE blocking between Type 1 PSFCH accessors, and Type 2A PSFCH accessors in a shared COT (at least those sharing UEs accessing after a gap >15 μs).

It is expected that when a UE1 performs a transmission, a CPE is used to fill the gap to reduce it up to 16 μs. However, if the COT is not shared by UE1, other UEs (e.g., UE2) would not have a chance to transmit their PSFCH communication, as shown by example 700. Not being able to transmit during a COT of another UE adds latency.

In some aspects, if UE2 is allowed to share the COT for the PSFCH occasion (with a CPE of 16 μs so that multiple consecutive slots transmission (MCSt) can be maintained by UE1 initiator), then UE2 may have a way to perform its high priority PSFCH transmission concurrently with UE1. This may include relaxing a restriction on COT sharing to allow transmission of the PSFCH communication if the COT interruption gap is less than 25 μs (e.g., 16 μs or less). In some scenarios, two CPE positions 702 may be needed for S-SSB or PSFCH, to allow 16 μs and 25 μs gaps in symbol #13.

As indicated above, FIG. 7 is provided as an example. Other examples may differ from what is described with regard to FIG. 7.

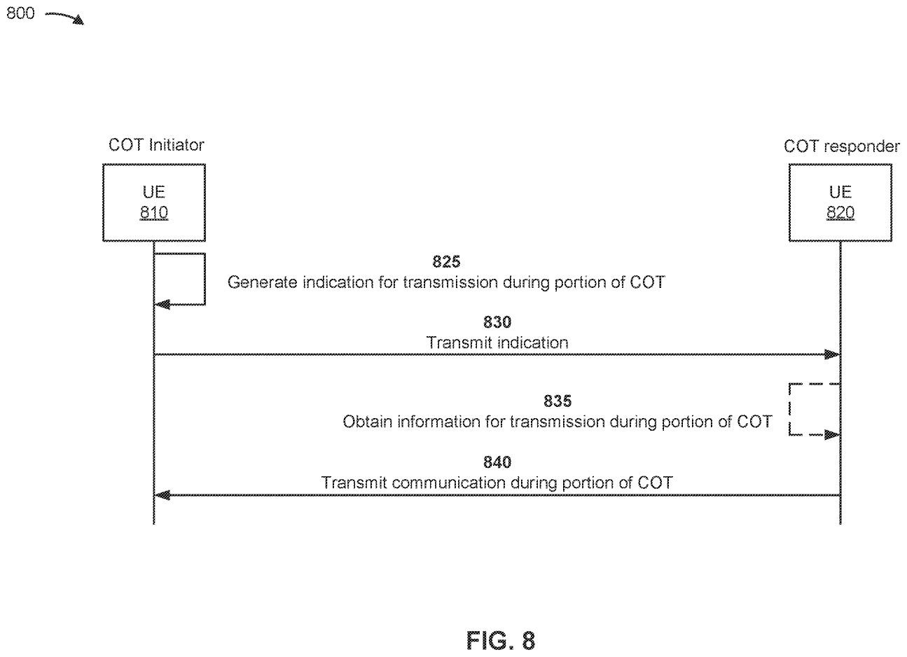

FIG. 8 is a diagram illustrating an example 800 associated with COT sharing, in accordance with the present disclosure. As shown in FIG. 8, a first UE 810 (e.g., a UE 120) and a second UE 820 (e.g., a UE 120) may communicate with one another via a sidelink. UE 810 may be a COT initiator, and UE 820 may be a COT responder or a PSFCH transmitter,

As shown by reference number 825, UE 810 may generate an indication for transmission of a communication during a portion of a COT used by the first UE. The portion may be smaller in duration than the whole COT. As shown by reference number 830, UE 810 may transmit the indication. UE 820 may receive the indication. In some aspects, the indication may be of a special COT sharing (only shared resources are S-SSB slots and PSFCH symbols), where it is possible that UE 820 transmissions are concurrent to UE 810's transmissions. In some aspects, as shown by reference number 835, UE 820 may alternatively obtain information about transmitting a communication during the portion of the COT from configuration information. As shown by reference number 840, UE 820 may transmit a communication during the portion of the COT. The communication may be an S-SSB, a PSFCH communication, or another high priority communication.

As indicated above, FIG. 8 is provided as an example. Other examples may differ from what is described with respect to FIG. 8.

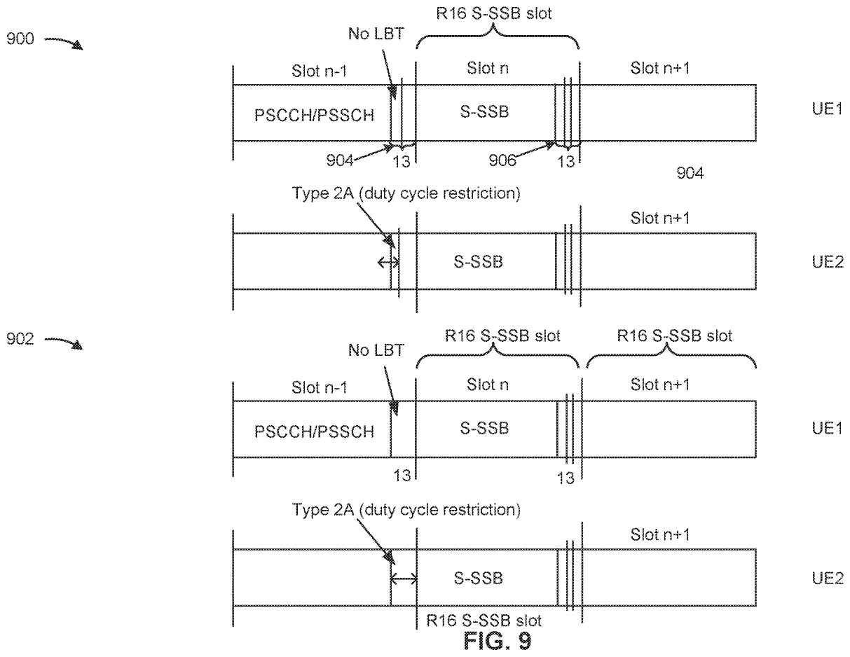

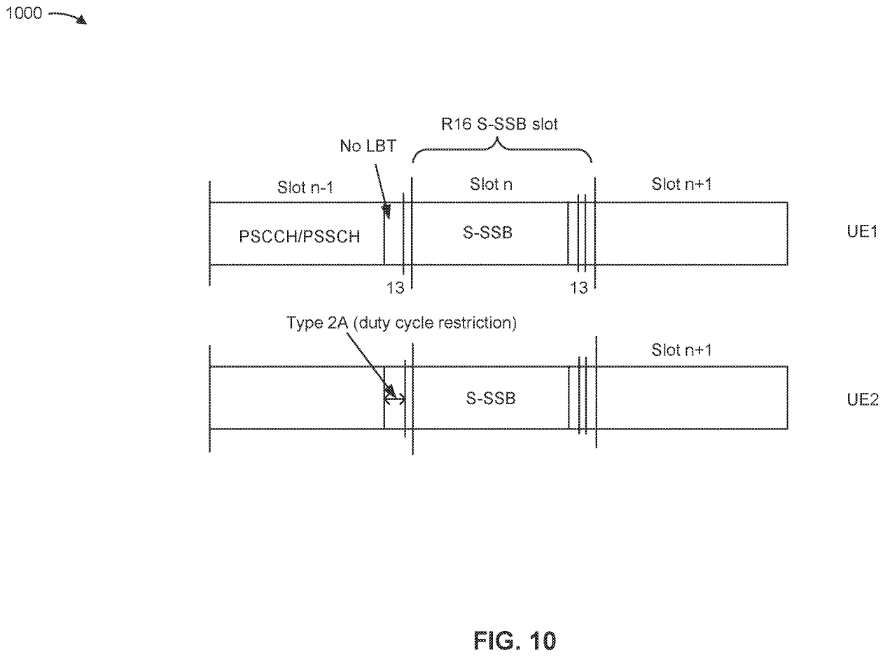

FIGS. 9 and 10 are diagrams illustrating examples 900, 902, and 1000 of using COT interruption gaps 904 and 906, in accordance with the present disclosure. In examples 900, UE1 does not perform LBT in the COT interruption gap 904. UE2 performs a type 2A LBT in COT interruption gap 904. The CPE in COT interruption gap 904 in example 900 is earlier than in example 902, The CPE is smaller in example 1000 of FIG. 10.

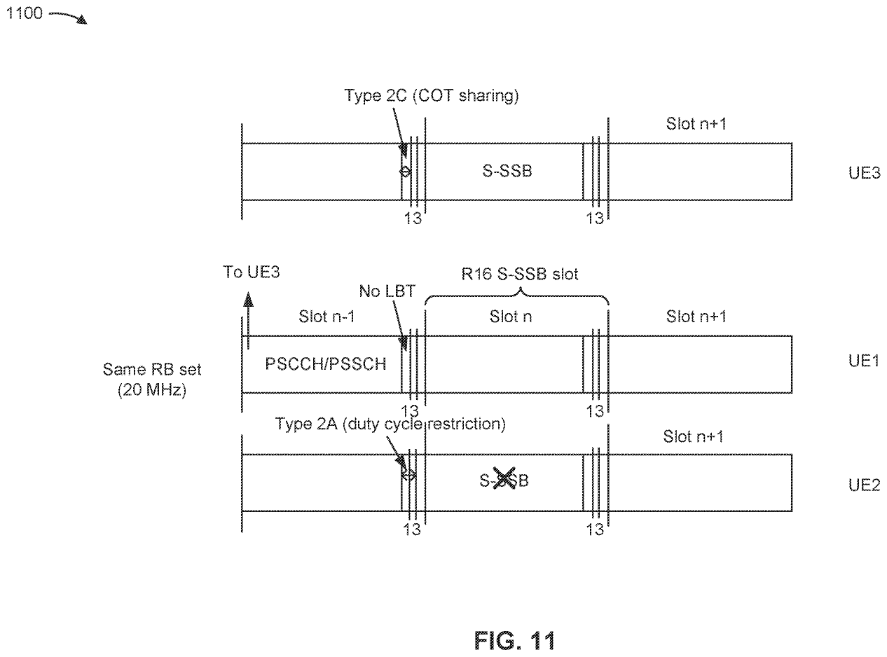

FIG. 11 is a diagram illustrating an example 1100 of responder UE transmission, in accordance with the present disclosure.

Even if a COT is shared by UE1 (e.g., to UE3), current rules for a responder UE may gate (e.g., block, limit, or deprioritize) the transmission of the S-SSB from UE2 if UE2 was not a target of COT-SI, which can also introduce latency if UE2 has to wait until after the COT to transmit. Example 1100 shows possible transmissions from UE1, UE2, and UE3. The S-SSB of UE2 is marked as blocked. In some aspects, the definition of “responder UE” may be relaxed when the objective is S-SSB transmission. That is, UE2 may not be a COT target (responder UE) of UEL, but UE2 may transmit in a portion of the COT as if UE2 was a responder UE. The ID matching check for UE2 may be skipped. As a result, latency is reduced.

As indicated above, FIG. 11 is provided as an example. Other examples may differ from what is described with regard to FIG. 11.

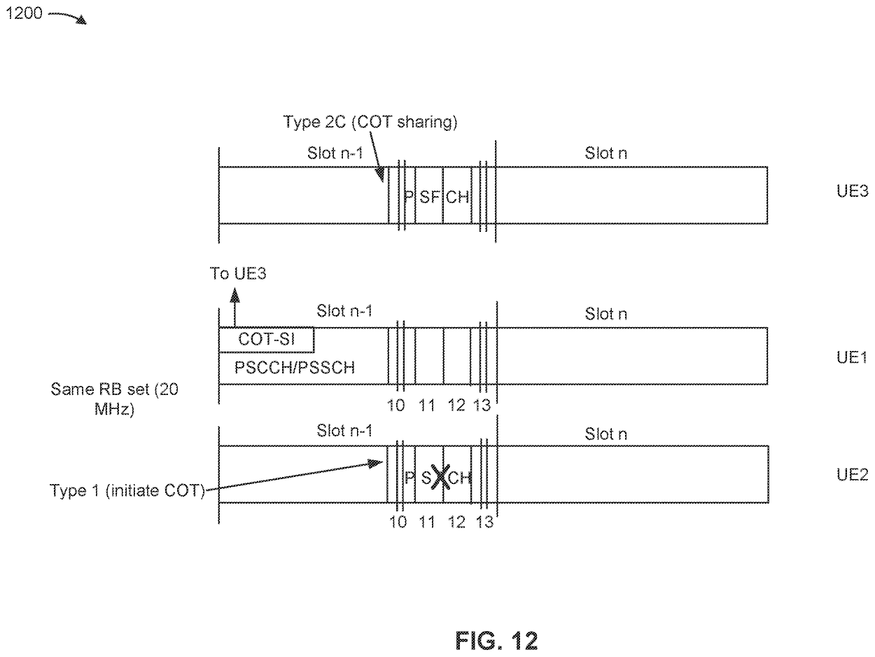

FIG. 12 is a diagram illustrating an example 1200 of transmission during a COT, in accordance with the present disclosure.

Even if a COT is shared by a UE1 (e.g., to UE3), a current rule for a responder UE may gate the transmission of PSFCH from UE2 if UE2 was not a target of the COT-SI, which is not desirable. In some aspects, the UEs may relax the definition of “responder UE” when the objective is PSFCH transmission. As a result, latency is reduced.

As indicated above, FIG. 12 is provided as an example. Other examples may differ from what is described with regard to FIG. 12.

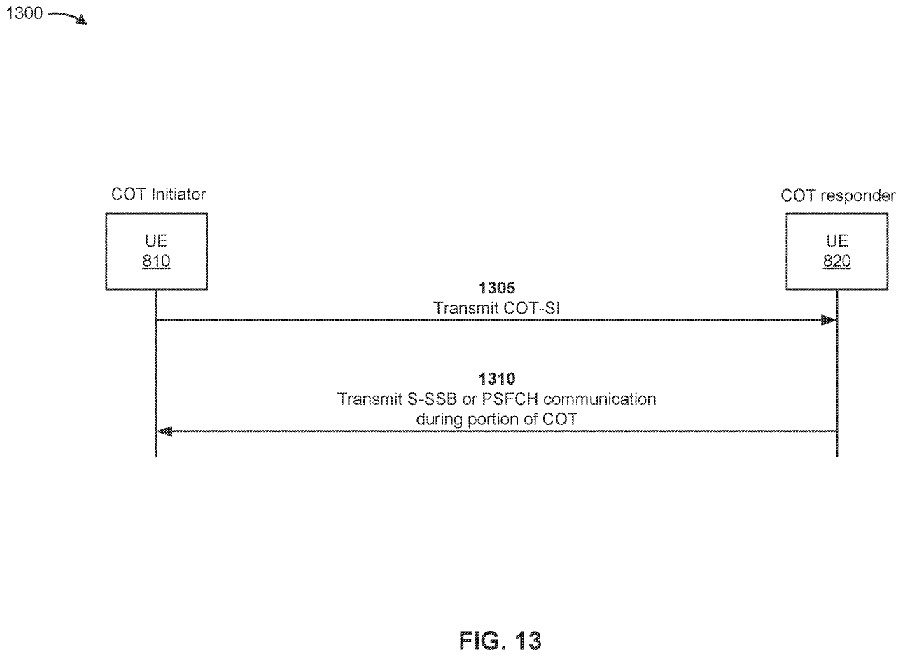

FIG. 13 is a diagram illustrating an example 1300 associated with a responder UE transmitting a communication during a COT of another UE, in accordance with the present disclosure.

In some aspects, UE1 may transmit COT-SI and UE2 may be a responder UE that can transmit a particular communication during a portion of the COT, such as an S-SSB or a PSFCH communication. By being able to transmit an S-SSB or a PSFCH communication during the portion of UE1's COT, UE2 may reduce latency in communications.

As shown by reference number 1305, the UE 810 may transmit COT-SI. The COT-SI may indicate a first indication of a first COT used by the UE 810 and that can be shared with the UE 820. In some aspects, UE1 may explicitly indicate that UE2 can be a responder UE that is allowed to transmit an S-SSB or a PSFCH communication during the portion of the COT.

Some COT rules may require a responder UE to be targeted by the initiator UE to transmit during a shared COT. This may include determining whether an ID of the receiving UE matches (e.g., equals or is otherwise sufficiently similar) a target ID in the COT-SI or in an indication. In some aspects, the UE 810 may explicitly indicate that the UE 820 can be a responder UE that is allowed to transmit an S-SSB or a PSFCH communication during the portion of the COT regardless or independently of whether an ID of the UE 820 matches a target ID from the UE 810. In some aspects, the UEs may use a relaxed definition (skipping the ID matching check) of responder for UEs intentioned to transmit S-SSB and/or PSFCH transmissions. The UE 820 may transmit in the portion of the COT based at least in part on a rule is specified for this behavior, an indicator in SCI (e.g. one bit) to control this behavior, or an RRC configuration to control this behavior. As shown by reference number 1310, the UE 820 may transmit an S-SSB or a PSFCH communication during the portion of the COT.

As indicated above, FIG. 13 is provided as an example. Other examples may differ from what is described with regard to FIG. 13.

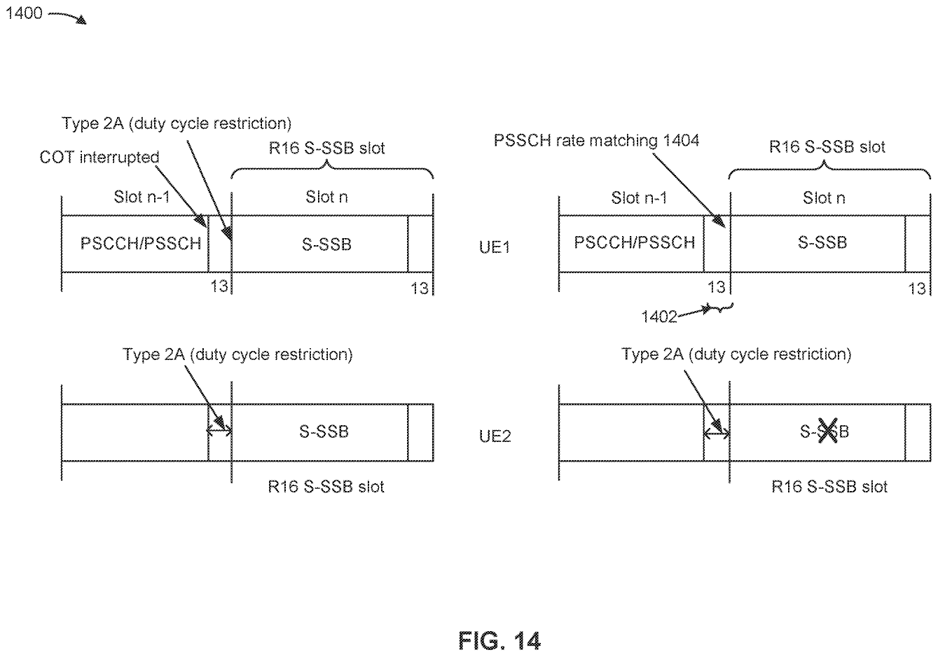

FIG. 14 is a diagram illustrating an example 1400 of using a COT, in accordance with the present disclosure.

In some aspects, a UE (UE1) may ensure contiguous TX on a burst without terminating the COT by using rate matching of a PSSCH in symbol #13. In some aspects, a unique CPE position may be set for S-SSB slots to length zero (at the slot boundary). UEs trying to access with Type 2A with duty cycle restriction will not block each other, since the measurement has a whole gap symbol.

In some aspects, if an initiator UE (UE1) wants to perform MCSt including the S-SSB slot, UE1 may preempt the slot by filling the gap symbol 1402 completely (with rate matching 1404), and therefore will block other UEs that want to transmit an S-SSB. Otherwise, UE1 may terminate the COT. This behavior can be decided by each UE (implementation), and allowed based at least in part on specified information in stored configuration information or base at least in part on an RRC configuration.

As indicated above, FIG. 14 is provided as an example. Other examples may differ from what is described with regard to FIG. 14.

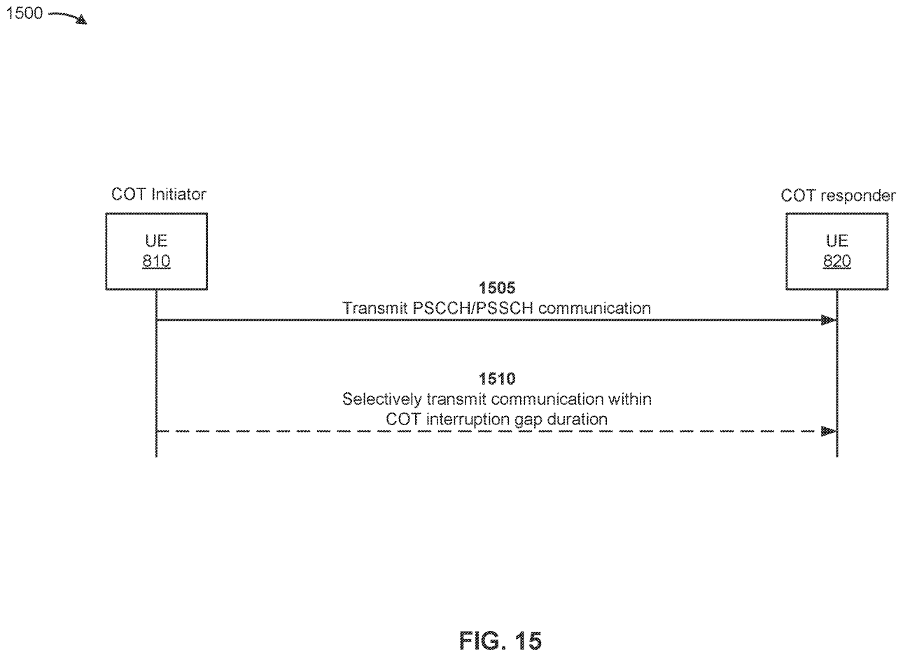

FIG. 15 is a diagram illustrating an example 1500 of using a COT, in accordance with the present disclosure.

As shown by reference number 1505, the UE 810 may transmitting a physical sidelink channel communication in a first portion of a COT used by the first UE. The communication may be a PSCCH communication and/or a PSSCH communication. The UE 810 may determine whether to use the remainder (second portion) of the COT. As shown by reference number 1510, the UE 810 may selectively transmit a communication in the second portion of the COT within a COT interruption gap duration based at least in part on a determination of whether the UE 810 is to use the second portion. In some aspects, the UE 810 may transmit the communication within the COT interruption gap duration based at least in part on the determination to use the second portion of the COT. Alternatively, in some aspects, the UE 810 may refrain from transmitting the communication within the COT interruption gap duration based at least in part on a determination to not use the second portion of the COT.

By selectively transmitting a communication based on a determination to use a COT. the UE 810 may have the ability to retain the COT or share the COT, depending on how protective or sharing the UE 810 is configured. This control may be used to reduce latency and conserve signaling resources.

As indicated above, FIG. 15 is provided as an example. Other examples may differ from what is described with regard to FIG. 15.

In some aspects, a new COT sharing definition may be focused on shared resources only in S-SSB and/or PSFCH occasions, where the initiator UE can indicate in SCI that the S-SSB slots and PSFCH symbols in its COT can be shared, regardless of the COT being formally shared (e.g., for PSCCH/PSSCH TXs) and potentially without ID matching check. In some aspects, a rule may be specified instead of an SCI indication. In some aspects, a RRC configuration may configured the UEs instead of an SCI indication.

In some aspects, an indication, a rule, and/or a configuration may be (a single or two separate) for both S-SSB and PSFCH, only for S-SSB, or only for PSFCH.

In some aspects, the indication may be (for a time-limited sharing or for the whole COT) for the next opportunity from the indicating transmission (implicitly stating that falls within a maximum COT (MCOT) duration) or for the whole COT (needs a COT duration indication).

In some aspects, each indication may have different values, and one or more of the following indications can be supported: not allowed to transmit, allowed to transit with ID checking, or allowed to transmit without ID checking.

In some aspects, a default CPE used by the responder UE may be for gap=16 μs. The COT initiator UE may leave a gap of 16 μs via CPE filling before each S-SSB and PSFCH communication occasion. The responder UE may perform Type 2C or Type 2B channel access in the gap (for single transmission it is intended that Type 2C would be used, if there is a longer S-SSB burst, e.g., exceeding 1 ms, Type 2B can be used). If multiple CPE positions are pre-configured (e.g., for PSFCH and/or S-SSB), the first position for a 16 μs gap may be considered the default position for this special COT sharing.

FIG. 16 is a diagram illustrating an example process 1600 performed, for example, by a first UE, in accordance with the present disclosure. Example process 1600 is an example where the first UE (e.g., UE 120, UE 810) performs operations associated with COT sharing for sidelink communications.

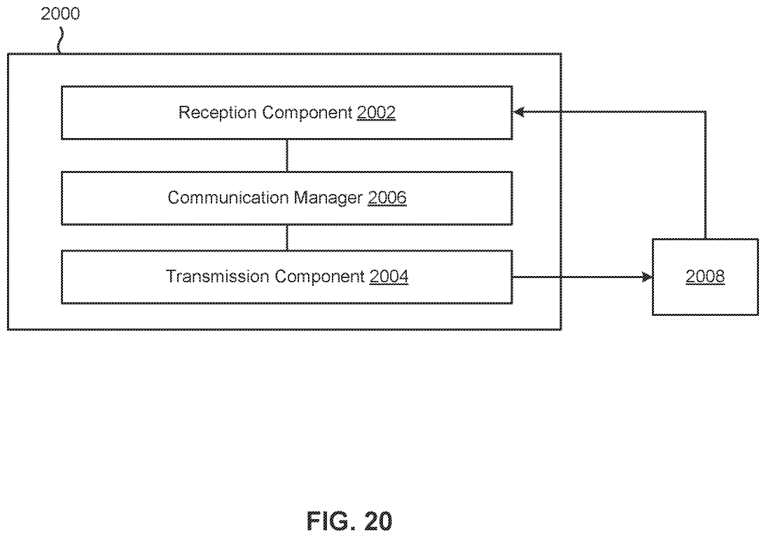

As shown in FIG. 16, in some aspects, process 1600 may include generating an indication that a second UE is able to transmit a communication during a portion of a COT used by the first UE, the portion being smaller in duration than the COT (block 1610). For example, the first UE (e.g., using communication manager 2006, depicted in FIG. 20) may generate an indication that a second UE is able to transmit a communication during a portion of a COT used by the first UE, the portion being smaller in duration than the COT, as described above.

As further shown in FIG. 16, in some aspects, process 1600 may include transmitting the indication to the second UE (block 1620). For example, the first UE (e.g., using transmission component 2004 and/or communication manager 2006, depicted in FIG. 20) may transmit the indication to the second UE, as described above.

Process 1600 may include additional aspects, such as any single aspect or any combination of aspects described below and/or in connection with one or more other processes described elsewhere herein.

In a first aspect, the communication is an S-SSB and does not comprise a PSFCH communication.

In a second aspect, alone or in combination with the first aspect, the communication is a PSFCH communication and does not comprise a sidelink synchronization signal block.

In a third aspect, alone or in combination with one or more of the first and second aspects, the communication is an S-SSB or a PSFCH communication.

In a fourth aspect, alone or in combination with one or more of the first through third aspects, the first UE is a COT initiator.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a second UE, in accordance with the present disclosure. Example process 1700 is an example where the second UE (e.g., UE 120, UE 820) performs operations associated with COT sharing for sidelink communications.

As shown in FIG. 17, in some aspects, process 1700 may include obtaining information that the second UE is able to transmit a communication during a portion of a COT used by a first UE, the portion being smaller in duration than the COT (block 1710). For example, the second UE (e.g., using reception component 2002 and/or communication manager 2006, depicted in FIG. 20) may obtain information that the second UE is able to transmit a communication during a portion of a COT used by a first UE, the portion being smaller in duration than the COT, as described above.

As further shown in FIG. 17, in some aspects, process 1700 may include transmitting the communication during the portion of the COT (block 1720), For example, the second UE (e.g., using transmission component 2004 and/or communication manager 2006, depicted in FIG. 20) may transmit the communication during the portion of the COT, as described above.

Process 1700 may include additional aspects, such as any single aspect or any combination of aspects described below and/or in connection with one or more other processes described elsewhere herein.

In a first aspect, the communication is an S-SSB and does not comprise a PSFCH communication.

In a second aspect, alone or in combination with the first aspect, the communication is a PSFCH communication and does not comprise a sidelink synchronization signal block.

In a third aspect, alone or in combination with one or more of the first and second aspects, the communication is an S-SSB or a PSFCH communication.

In a fourth aspect, alone or in combination with one or more of the first through third aspects, obtaining the information includes receiving the information from the first UE.

In a fifth aspect, alone or in combination with one or more of the first through fourth aspects, obtaining the information includes obtaining the information from stored configuration information or a radio resource control configuration.

In a sixth aspect, alone or in combination with one or more of the first through fifth aspects, transmitting the communication includes transmitting an S-SSB or a PSFCH communication based at least in part on a rule associated with transmitting communications during a portion of a COT.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a second UE, in accordance with the present disclosure. Example process 1800 is an example where the second UE (e.g., UE 120, UE 820) performs operations associated with COT sharing for sidelink communications.

As shown in FIG. 18, in some aspects, process 1800 may include obtaining a first indication of a first COT used by a first UE and that can be shared with the first UE (block 1810). For example, the second UE (e.g., using reception component 2002 and/or communication manager 2006, depicted in FIG. 20) may obtain a first indication of a first COT used by a first UE and that can be shared with the first UE, as described above, As further shown in FIG. 18, in some aspects, process 1800 may include transmitting an S-SSB or a PSFCH communication in a portion of the first COT, based at least in part on the first indication (block 1820). For example, the first UE (e.g., using transmission component 2004 and/or communication manager 2006, depicted in FIG. 20) may transmit an S-SSB or a PSFCH communication in a portion of the first COT, based at least in part on the first indication, as described above.

Process 1800 may include additional aspects, such as any single aspect or any combination of aspects described below and/or in connection with one or more other processes described elsewhere herein.

In a first aspect, the first indication indicates that the second UE is able to transmit the S-SSB or the PSFCH communication in the portion of the first COT.

In a second aspect, alone or in combination with the first aspect, the first indication or a configuration indicates that the second UE is able to transmit the S-SSB or the PSECH communication in the portion of the first COT independently of whether the second UE has an ID that matches a target ID indicated by the first indication.

In a third aspect, alone or in combination with one or more of the first and second aspects, obtaining the first indication includes receiving the first indication from the first UE.

In a fourth aspect, alone or in combination with one or more of the first through third aspects, obtaining the first indication includes obtaining the first indication from stored configuration information or a radio resource control configuration.

In a fifth aspect, alone or in combination with one or more of the first through fourth aspects, the first UE is a COT initiator, and the second UE is a COT responder.

In a sixth aspect, alone or in combination with one or more of the first through fifth aspects, the first indication indicates that S-SSB slots or PSFCH symbols in the first COT can be shared.

In a seventh aspect, alone or in combination with one or more of the first through sixth aspects, the second UE becomes a COT initiator, and process 1800 includes transmitting a second indication that the first UE is able to use a region of a second COT used by the second UE to transmit an S-SSB or a PSFCH communication.

In an eighth aspect, alone or in combination with one or more of the first through seventh aspects, the second indication indicates that the first UE is able to use the region of the second COT to transmit an S-SSB or a PSFCH communication, independently of whether the first UE has an ID that matches a target ID indicated by the second indication.

In a ninth aspect, alone or in combination with one or more of the first through eighth aspects, the first indication indicates that only the portion of the COT is shared.

In a tenth aspect, alone or in combination with one or more of the first through ninth aspects, the first indication indicates whether ID matching is to be performed for COT sharing.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, by a first UE, in accordance with the present disclosure. Example process 1900 is an example where the first UE (e.g., UE 120, UE 810, UE 820) performs operations associated with COT sharing for sidelink communications.

As shown in FIG. 19, in some aspects, process 1900 may include transmitting a physical sidelink channel communication in a first portion of a COT used by the first UE (block 1910). For example, the first UE (e.g., using transmission component 2004 and/or communication manager 2006, depicted in FIG. 20) may transmit a physical sidelink channel communication in a first portion of a COT used by the first UE, as described above.

As further shown in FIG. 19, in some aspects, process 1900 may include selectively transmitting a communication in a second portion of the COT within a COT interruption gap duration based at least in part on a determination of whether the first UE is to use the second portion (block 1920). For example, the first UE (e.g., using transmission component 2004 and/or communication manager 2006, depicted in FIG. 20) may selectively transmit a communication in a second portion of the COT within a COT interruption gap duration based at least in part on a determination of whether the first UE is to use the second portion, as described above.

Process 1900 may include additional aspects, such as any single aspect or any combination of aspects described below and/or in connection with one or more other processes described elsewhere herein.

In a first aspect, selectively transmitting the communication within the COT interruption gap duration based at least in part on the determination of whether the first UE is to use the second portion includes transmitting the communication within the COT interruption gap duration based at least in part on the determination to use the second portion of the COT, or refraining from transmitting the communication within the COT interruption gap duration based at least in part on a determination to not use the second portion of the COT.

In a second aspect, alone or in combination with the first aspect, the communication is a sidelink synchronization signal block.

In a third aspect, alone or in combination with one or more of the first and second aspects, the communication is a PSFCH communication.

In a fourth aspect, alone or in combination with one or more of the first through third aspects, the communication is a physical sidelink channel communication.

In a fifth aspect, alone or in combination with one or more of the first through fourth aspects, process 1900 includes transmitting a CPE that is based at least in part on a default CPE duration that is associated with the COT interruption gap duration.

In a sixth aspect, alone or in combination with one or more of the first through fifth aspects, the default CPE duration is 16 microseconds.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram of an example apparatus 2000 for wireless communication, in accordance with the present disclosure. The apparatus 2000 may be a UE, or a UE may include the apparatus 2000. In some aspects, the apparatus 2000 includes a reception component 2002, a transmission component 2004, and/or a communication manager 2006, which may be in communication with one another (for example, via one or more buses and/or one or more other components). In some aspects, the communication manager 2006 is the communication manager 140 described in connection with FIG. 1. As shown, the apparatus 2000 may communicate with another apparatus 2008, such as a UE or a network node (such as a CU, a DU, an RU, or a base station), using the reception component 2002 and the transmission component 2004.

In some aspects, the apparatus 2000 may be configured to perform one or more operations described herein in connection with FIGS. 1-15. Additionally, or alternatively, the apparatus 2000 may be configured to perform one or more processes described herein, such as process 1600 of FIG. 16, process 1700 of FIG. 17, process 1800 of FIG. 18, process 1900 of FIG. 19, or a combination thereof. In some aspects, the apparatus 2000 and/or one or more components shown in FIG. 20 may include one or more components of the UE described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2008. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a demodulator, a MIMO detector, a receive processor, a controller/processor, a memory, or a combination thereof, of the UE described in connection with FIG. 2.

The transmission component 2004 may transmit communications, such as reference signals, control information, data communications, or a combination thereof, to the apparatus 2008. In some aspects, one or more other components of the apparatus 2000 may generate communications and may provide the generated communications to the transmission component 2004 for transmission to the apparatus 2008. In some aspects, the transmission component 2004 may perform signal processing on the generated communications (such as filtering. amplification, modulation, digital-to-analog conversion, multiplexing, interleaving, mapping, or encoding, among other examples), and may transmit the processed signals to the apparatus 2008. In some aspects, the transmission component 2004 may include one or more antennas, a modem, a modulator, a transmit MIMO processor, a transmit processor, a controller/processor, a memory, or a combination thereof, of the UE described in connection with FIG. 2. In some aspects, the transmission component 2004 may be co-located with the reception component 2002 in a transceiver.

The communication manager 2006 may support operations of the reception component 2002 and/or the transmission component 2004. For example, the communication manager 2006 may receive information associated with configuring reception of communications by the reception component 2002 and/or transmission of communications by the transmission component 2004. Additionally, or alternatively, the communication manager 2006 may generate and/or provide control information to the reception component 2002 and/or the transmission component 2004 to control reception and/or transmission of communications.

In some aspects associated with a first UE, the communication manager 2006 may generate an indication that a second UE is able to transmit a communication during a portion of a COT used by the first UE, the portion being smaller in duration than the COT. The transmission component 2004 may transmit the indication to the second UE.

In some aspects associated with a second UE, the reception component 2002 may obtain information that the second UE is able to transmit a communication during a portion of a COT used by a first UE, the portion being smaller in duration than the COT. The transmission component 2004 may transmit the communication during the portion of the COT,

In some aspects associated with a second UE, the reception component 2002 may obtain a first indication of a first COT used by a first UE and that can be shared with the first UE. The transmission component 2004 may transmit an S-SSB or a PSFCH communication in a portion of the first COT, based at least in part on the first indication.

In some aspects associated with a second UE, the transmission component 2004 may transmit a physical sidelink channel communication in a first portion of a COT used by the first UE. The transmission component 2004 may selectively transmit a communication in a second portion of the COT within a COT interruption gap duration based at least in part on a determination of whether the first UE is to use the second portion.

The transmission component 2004 may transmit a CPE that is based at least in part on a default CPE duration that is associated with the COT interruption gap duration.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

The following provides an overview of some Aspects of the present disclosure:
Aspect 1: A method of wireless communication performed by a first user equipment (UE), comprising: generating an indication that a second UE is able to transmit a communication during a portion of a channel occupancy time (COT) used by the first UE, the portion being smaller in duration than the COT; and transmitting the indication to the second UE.
Aspect 2: The method of Aspect 1, wherein the communication is a sidelink synchronization signal block and does not comprise a physical sidelink feedback channel communication.
Aspect 3: The method of Aspect 1, wherein the communication is a physical sidelink feedback channel communication and does not comprise a sidelink synchronization signal block.
Aspect 4: The method of Aspect 1, wherein the communication is a sidelink synchronization signal block or a physical sidelink feedback channel communication.
Aspect 5: The method of any of Aspects 1-4, wherein the first UE is a COT initiator.
Aspect 6: A method of wireless communication performed by a second user equipment (UE), comprising: obtaining information that the second UE is able to transmit a communication during a portion of a channel occupancy time (COT) used by a first UE, the portion being smaller in duration than the COT; and transmitting the communication during the portion of the COT.
Aspect 7: The method of Aspect 6, wherein the communication is a sidelink synchronization signal block and does not comprise a physical sidelink feedback channel communication.
Aspect 8: The method of Aspect 6, wherein the communication is a physical sidelink feedback channel communication and does not comprise a sidelink synchronization signal block.
Aspect 9: The method of Aspect 6, wherein the communication is a sidelink synchronization signal block or a physical sidelink feedback channel communication.
Aspect 10: The method of any of Aspects 6-9, wherein obtaining the information includes receiving the information from the first UE.
Aspect 11: The method of any of Aspects 6-10, wherein obtaining the information includes obtaining the information from stored configuration information or a radio resource control configuration.
Aspect 12: The method of any of Aspects 6-11, wherein transmitting the communication includes transmitting a sidelink synchronization signal block or a physical sidelink feedback channel communication based at least in part on a rule associated with transmitting communications during a portion of a COT.
Aspect 13: A method of wireless communication performed by a second user equipment (UE), comprising: obtaining a first indication of a first channel occupancy time (COT) used by a first UE and that can be shared with the first UE; and transmitting a sidelink synchronization signal block (S-SSB) or a physical sidelink feedback channel (PSFCH) communication in a portion of the first COT, based at least in part on the first indication.
Aspect 14: The method of Aspect 13, wherein the first indication indicates that the second UE is able to transmit the S-SSB or the PSFCH communication in the portion of the first COT.
Aspect 15: The method of any of Aspects 13-14, wherein the first indication or a configuration indicates that the second UE is able to transmit the S-SSB or the PSFCH communication in the portion of the first COT independently of whether the second UE has an ID that matches a target ID indicated by the first indication.
Aspect 16: The method of any of Aspects 13-15, wherein obtaining the first indication includes receiving the first indication from the first UE.
Aspect 17: The method of any of Aspects 13-16, wherein obtaining the first indication includes obtaining the first indication from stored configuration information or a radio resource control configuration.
Aspect 18: The method of any of Aspects 13-17, wherein the first UE is a COT initiator, and the second UE is a COT responder.
Aspect 19: The method of any of Aspects 13-18, wherein the first indication indicates that S-SSB slots or PSFCH symbols in the first COT can be shared.
Aspect 20: The method of any of Aspects 13-19, wherein the second UE becomes a COT initiator, and wherein the method comprises transmitting a second indication that the first UE is able to use a region of a second COT used by the second UE to transmit an S-SSB or a PSFCH communication.
Aspect 21: The method of Aspect 20, wherein the second indication indicates that the first UE is able to use the region of the second COT to transmit an S-SSB or a PSFCH communication, independently of whether the first UE has an ID that matches a target ID indicated by the second indication.
Aspect 22: The method of any of Aspects 13-21, wherein the first indication indicates that only the portion of the COT is shared.
Aspect 23: The method of any of Aspects 13-22, wherein the first indication indicates whether ID matching is to be performed for COT sharing.
Aspect 24: The method of any of Aspects 13-14, wherein transmitting the S-SSB or the PSFCH includes transmitting the S-SSB or the PSFCH in a portion of the first COT based at least in part on a source identifier (ID) of the first indication matching a source ID of a unicast from the first UE and a destination ID of the first indication matching a destination ID of the unicast.
Aspect 25: The method of any of Aspects 13-14, wherein transmitting the S-SSB or the PSFCH includes transmitting the S-SSB or the PSFCH in a portion of the first COT based at least in part on a destination identifier (ID) of the first indication matching a destination ID of a broadcast or multicast.
Aspect 26: A method of wireless communication performed by a first user equipment (UE), comprising: transmitting a physical sidelink channel communication in a first portion of a channel occupancy time (COT) used by the first UE; and selectively transmitting a communication in a second portion of the COT within a COT interruption gap duration based at least in part on a determination of whether the first UE is to use the second portion.
Aspect 27: The method of Aspect 26, wherein selectively transmitting the communication within the COT interruption gap duration based at least in part on the determination of whether the first UE is to use the second portion includes: transmitting the communication within the COT interruption gap duration based at least in part on the determination to use the second portion of the COT, or refraining from transmitting the communication within the COT interruption gap duration based at least in part on a determination to not use the second portion of the COT.
Aspect 28: The method of any of Aspects 26-27, wherein the communication is a sidelink synchronization signal block.
Aspect 29: The method of any of Aspects 26-27, wherein the communication is a physical sidelink feedback channel communication.
Aspect 30: The method of any of Aspects 26-27, wherein the communication is a physical sidelink channel communication.
Aspect 31: The method of any of Aspects 26-30, further comprising transmitting a cyclic prefix extension (CPE) that is based at least in part on a default CPE duration that is associated with the COT interruption gap duration.
Aspect 32: The method of Aspect 30, wherein the default CPE duration is 16 microseconds.
Aspect 33: An apparatus for wireless communication at a device, comprising a processor; memory coupled with the processor, and instructions stored in the memory and executable by the processor to cause the apparatus to perform the method of one or more of Aspects 1-32.
Aspect 34: A device for wireless communication, comprising a memory and one or more processors coupled to the memory, the one or more processors configured to perform the method of one or more of Aspects 1-32.
Aspect 35: An apparatus for wireless communication, comprising at least one means for performing the method of one or more of Aspects 1-32.
Aspect 36: A non-transitory computer-readable medium storing code for wireless communication, the code comprising instructions executable by a processor to perform the method of one or more of Aspects 1-32.
Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, individually or collectively configured to:
generate an indication that a second UE is able to transmit a communication during a portion of a channel occupancy time (COT) used by the first UE, the portion being smaller in duration than the COT; and
transmit the indication to the second UE.

2. The first UE of claim 1, wherein the communication is a sidelink synchronization signal block and does not comprise a physical sidelink feedback channel communication.

3. The first UE of claim 1, wherein the communication is a physical sidelink feedback channel communication and does not comprise a sidelink synchronization signal block.

4. The first UE of claim 1, wherein the first UE is a COT initiator, and wherein the communication is a sidelink synchronization signal block or a physical sidelink feedback channel communication.

5. A second user equipment (UE) for wireless communication, comprising:
a memory; and
one or more processors, coupled to the memory, individually or collectively configured to:
obtain a first indication of a first channel occupancy time (COT) used by a first UE and that can be shared with the first UE; and
transmit a sidelink synchronization signal block (S-SSB) or a physical sidelink feedback channel (PSFCH) communication in a portion of the first COT, based at least in part on the first indication.

6. The second UE of claim 5, wherein the first indication indicates that the second UE is able to transmit the S-SSB or the PSFCH communication in the portion of the first COT.

7. The second UE of claim 5, wherein the first indication or a configuration indicates that the second UE is able to transmit the S-SSB or the PSFCH communication in the portion of the first COT independently of whether the second UE has an identifier (ID) that matches a target ID indicated by the first indication.

8. The second UE of claim 5, wherein the one or more processors, to obtain the first indication, are configured to obtain the first indication from stored configuration information or a radio resource control configuration.

9. The second UE of claim 5, wherein the first UE is a COT initiator, and the second UE is a COT responder.

10. The second UE of claim 5, wherein the first indication indicates that S-SSB slots or PSFCH symbols in the first COT can be shared.

11. The second UE of claim 5, wherein the second UE becomes a COT initiator, and wherein the one or more processors are configured to transmit a second indication that the first UE is able to use a region of a second COT used by the second UE to transmit an S-SSB or a PSFCH communication.

12. The second UE of claim 11, wherein the second indication indicates that the first UE is able to use the region of the second COT to transmit an S-SSB or a PSFCH communication, independently of whether the first UE has an identifier (ID) that matches a target ID indicated by the second indication.

13. The second UE of claim 5, wherein the first indication indicates that only the portion of the COT is shared.

14. The second UE of claim 5, wherein the first indication indicates whether identifier (ID) matching is to be performed for COT sharing.

15. The second UE of claim 5, wherein to transmit the S-SSB or the PSFCH, the one or more processors are configured to transmit the S-SSB or the PSFCH in a portion of the first COT based at least in part on a source identifier (ID) of the first indication matching a source ID of a unicast from the first UE and a destination ID of the first indication matching a destination ID of the unicast.

16. The second UE of claim 5, wherein to transmit the S-SSB or the PSFCH, the one or more processors are configured to transmit the S-SSB or the PSFCH in a portion of the first COT based at least in part on a destination identifier (ID) of the first indication matching a destination ID of a broadcast or multicast.

17. A first user equipment (UE) for wireless communication, comprising:
a memory; and
one or more processors, coupled to the memory, configured to:
transmit a physical sidelink channel communication in a first portion of a channel occupancy time (COT) used by the first UE; and
selectively transmit a communication in a second portion of the COT within a COT interruption gap duration based at least in part on a determination of whether the first UE is to use the second portion.

18. The first UE of claim 17, wherein the one or more processors, to selectively transmit the communication within the COT interruption gap duration based at least in part on the determination of whether the first UE is to use the second portion, are configured to:
transmit the communication within the COT interruption gap duration based at least in part on the determination to use the second portion of the COT, or
refrain from transmitting the communication within the COT interruption gap duration based at least in part on a determination to not use the second portion of the COT.

19. The first UE of claim 17, wherein the communication is a sidelink synchronization signal block, a physical sidelink feedback channel communication, or a physical sidelink channel communication.

20. The first UE of claim 17, wherein the one or more processors are further configured to transmit a cyclic prefix extension (CPE) that is based at least in part on a default CPE duration that is associated with the COT interruption gap duration.
